(19) United States
(12) Patent Application Publication
(10) Pub. No.: US 2017/0036715 A1
(43) Pub. Date: Feb. 9, 2017

(54) METHOD OF COUPLING TRACK SHOE WITH TRACK LINK OF TRACK ASSEMBLY

(71) Applicant: Caterpillar Inc., Peoria, IL (US)

(72) Inventor: Eric J. Johannsen, Washington, IL (US)

(73) Assignee: CATERPILLAR INC., Peoria, IL (US)

(21) Appl. No.: 14/729,081

(22) Filed: Jun. 3, 2015

(51) Int. Cl. B62D 55/32

(52) U.S. Cl. CPC B62D 55/32; E02F 3/7604

(57) ABSTRACT

A method of coupling a track shoe with a track link of a track assembly is disclosed. The track shoe defines a plurality of first openings. The method includes disposing the track shoe on the track link. The method includes disposing a plate member on the track shoe such that each of a plurality of second openings of the plate member is aligned with a corresponding first opening of the plurality of first openings of the track shoe. The plate member includes a retaining portion disposed adjacent to each of the plurality of second openings. The method includes inserting a fastening member through each of the plurality of second openings and the corresponding first opening. The method includes coupling, via the fastening member, the track shoe with the track link. The method further includes bending the retaining portion such that the retaining portion is disposed adjacent to the fastening member.

### TECHNICAL FIELD

The present disclosure relates to a method of coupling a track shoe with a track link of a track assembly.

### BACKGROUND

Machines, such as a track type tractor, employ track assemblies as ground engaging members which provide propulsion to the machine. The track assembly includes track links coupled to track shoes. Typically, fasteners, such as bolts, are used to couple the track links to the track shoe. Since the track assembly engages a ground surface during operation of the machine, the track shoes may tend to move relative to the track links. This may cause movement and eventually lead to loosening of the fasteners.

To prevent such movement and/or loosening of the fasteners, various methods, such as a torque and turn method, are used to assemble the fasteners with the track shoes and the track links. Though such assembly methods may be carried out within a factory, it may be difficult to implement the assembly methods during servicing and/or maintenance due to requirement of specialized tools and equipment.

For reference, JP Patent Number 58101879 (the '879 publication) discloses a vertical plate-like stud which is formed between two bolt holes at a bottom face of an opening of a main body and integrated with said main body at a top face of the opening. The stud is disposed such that both its ends thereof have nut contact faces which make contact with the bottom face of the opening and cross at a right angle with the center line of the main body. Wall faces which are contiguous with the longitudinal end parts of the opening of the main body have nut contact faces and in such a relation that they make contact with the bottom faces thereof and cross at a right angle with the center line of the main body. However, the method of assembling the stud with the nuts, as disclosed in the '879 publication, may be time consuming and complex. Moreover, the method requires a change in the link design, and hence may not be an easily retrofittable solution.

### SUMMARY OF THE DISCLOSURE

In an aspect of the present disclosure, a method of coupling a track shoe with a track link of a track assembly is provided. The track shoe defines a plurality of first openings. The method includes disposing the track shoe on the track link. The method also includes disposing a plate member on the track shoe such that each of a plurality of second openings of the plate member is aligned with a corresponding first opening of the plurality of first openings of the track shoe. The plate member further includes a retaining portion disposed adjacent to each of the plurality of second openings. Each of the plurality of second openings defines a longitudinal axis therethrough. Further, the retaining portion extends along a direction substantially perpendicular to the longitudinal axis. The method also includes inserting a fastening member through each of the plurality of second openings and the corresponding first opening. The method also includes coupling, via the fastening member, the track shoe with the track link. The method further includes bending the retaining portion such that the retaining portion extends substantially parallel to the longitudinal axis and is disposed adjacent to the fastening member.

Other features and aspects of this disclosure will be apparent from the following description and the accompanying drawings.

### BRIEF DESCRIPTION OF THE DRAWINGS

FIG. 1 illustrates a side view of an exemplary machine having an undercarriage;

FIG. 2 illustrates an exploded perspective view of a track shoe and track link assembly of the undercarriage having a plate member, according to an embodiment of the present disclosure;

FIG. 3 illustrates an assembled perspective view of the track shoe and track link assembly of FIG. 2;

FIG. 4 illustrates an assembled perspective view of the track shoe and track link assembly with a retaining portion of the plate member in an upright position, according to an embodiment of the present disclosure;

FIG. 5 illustrates a perspective view of the track shoe and track link assembly, according to another embodiment of the present disclosure ; and

FIG. 6 is a flow chart of a method of coupling the track shoe with the track link of a track assembly of the undercarriage, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

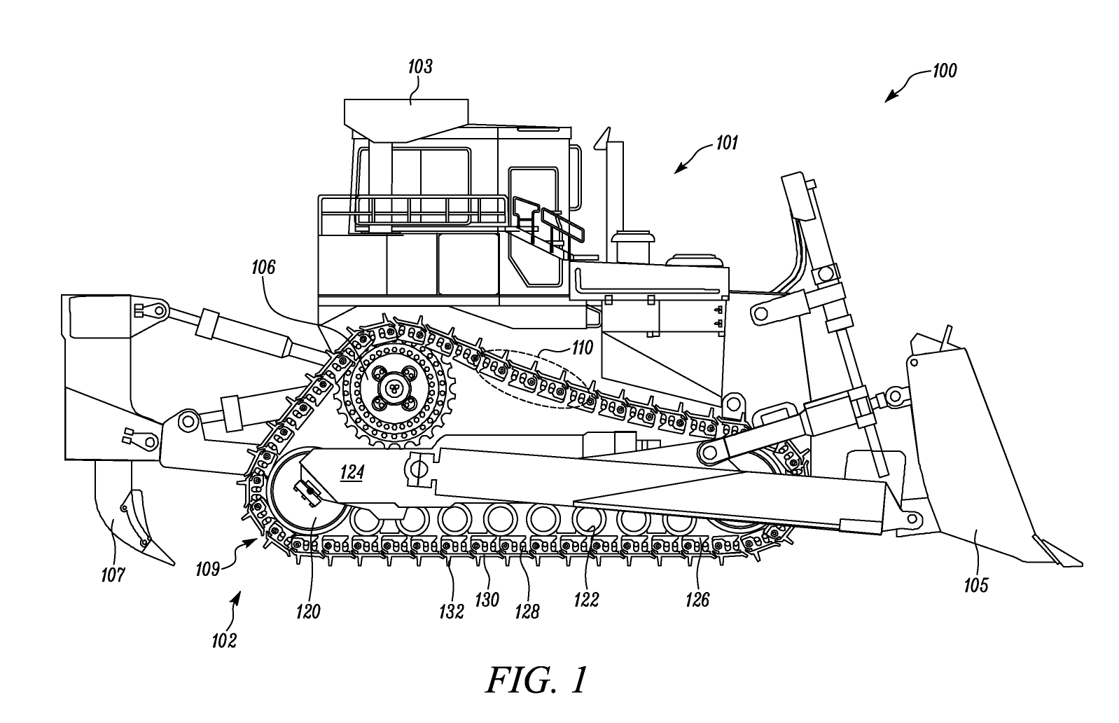

FIG. 1 shows an exemplary machine 100. In the illustrated embodiment, the machine 100 is a track-type tractor. However, the present disclosure may be embodied in any type of machine having an undercarriage assembly, for example, skid steers, dozers, excavators, backhoes, track loaders, and the like.

The machine 100 includes an upper body 101 supported by an undercarriage 102. The upper body 101 may include an operator cabin 103. Further, a power source (not shown), such as an engine, may be disposed in the upper body 101. The power source may be configured to generate power to propel the machine 100, and operate a first implement 105 and a second implement 107 of the machine 100. In the illustrated embodiment, the first and second implements 105, 107 are a blade assembly and a ripper, respectively.

The undercarriage 102 may include a pair of track assemblies 109 (only one shown) on opposing sides of the machine 100. The track assembly 109 includes a track 110, a drive sprocket 106, at least one idler 120, multiple track rollers 122, and a frame assembly 124. The track 110 may form a continuous structure operatively coupled to the drive sprocket 106, the idlers 120, and the track rollers 122. Further, the power source of the machine 100 may transmit power to the drive sprocket 106 via a driving mechanism (not shown). The driving mechanism may include a mechanical drive, a hydraulic drive, an electric drive, or a combination thereof.

The frame assembly 124 may carry the idlers 120. The frame assembly 124 may include multiple members (not shown) movable longitudinally relative to one another. During operation, a relative movement between the members of the frame assembly 124 may move the idlers 120 relative to one another. Further, rotation of the drive sprocket 106 may drive the track 110 to move around the drive sprocket 106, the idlers 120, and the track rollers 122 to engage a ground surface, and thereby propel the machine 100. The drive sprocket 106 may be driven in different directions to propel the machine 100 in forward or reverse directions. Further, the machine 100 may be steered by providing differential power to the drive sprockets 106 of the corresponding track assemblies 109.

In the illustrated embodiment, the track 110 includes a number of interconnected track links 126. Adjacent track links 126 are rotatably coupled together via a track pin assembly 128. The track pin assembly 128 is engaged by teeth of the drive sprocket 106 to drive the track 110 around the drive sprocket 106, the idlers 120, and the track rollers 122.

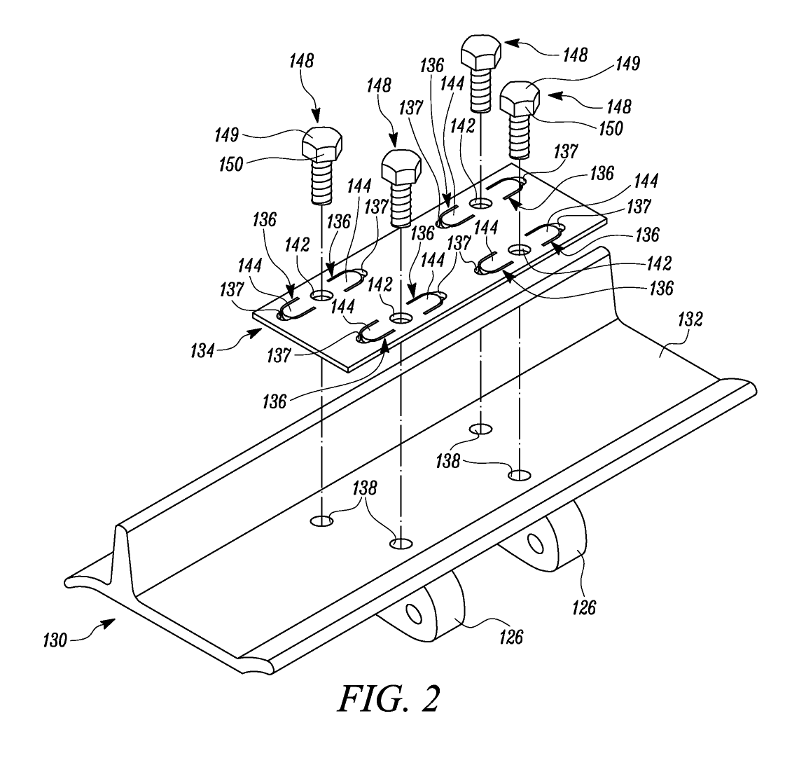

Referring to FIGS. 1 and 2, the track 110 further includes a number of track shoes 130 secured to the track links 126. In the illustrated embodiment, each of the track shoes 130 is secured to two track links 126. However, in an alternate embodiment, each of the track shoes 130 is secured to one track link 126. Each of the track links 126 may define a plurality of holes (not shown). In an example, the holes are through holes. However, in various alternate embodiments, the holes may be blind holes. Further, each track shoe 130 may include a ground engaging portion 132 adapted to contact the ground. The ground engaging portion 132 may include one or more portions (e.g., grouser bars) that provide increased traction between the track shoes 130 and the ground. It should be understood that the various components of the undercarriage 102, as described above, are purely exemplary and not intended to be limiting of the present disclosure.

FIG. 2 shows one of the track shoes 130 and the corresponding track links 126 of the track 110. The track shoe 130 defines a plurality of first openings 138. In the illustrated embodiment, the track shoe 130 defines four first openings 138. However, it may be contemplated that the track shoe 130 may include any number of first openings 138. Further, as illustrated in FIG. 2, a plate member 134 is disposed on the track shoe 130. The plate member 134 defines a plurality of second openings 142. In the illustrated embodiment, the plate member 134 defines four second openings 142 corresponding to the four first openings 138 of the track shoe 130. The plate member 134 further defines multiple notches 136 disposed around the second openings 142. The notches 136 may be cut in the plate member 134 to define a retaining portion 144. In the illustrated embodiment, the retaining portions 144 are integral with the plate member 134. In the illustrated embodiment, the plate member 134 includes two notches 136 defined around each of the second openings 142. Further, two retaining portions 144 are disposed adjacent to each of the second openings 142. Each of the notches 136 includes a portion 137 adjacent to the retaining portion 144. The portion 137 defines a clearance between an end of the retaining portion 144 and the plate member 134. In an example, the plate member 134 is made of soft steel plate.

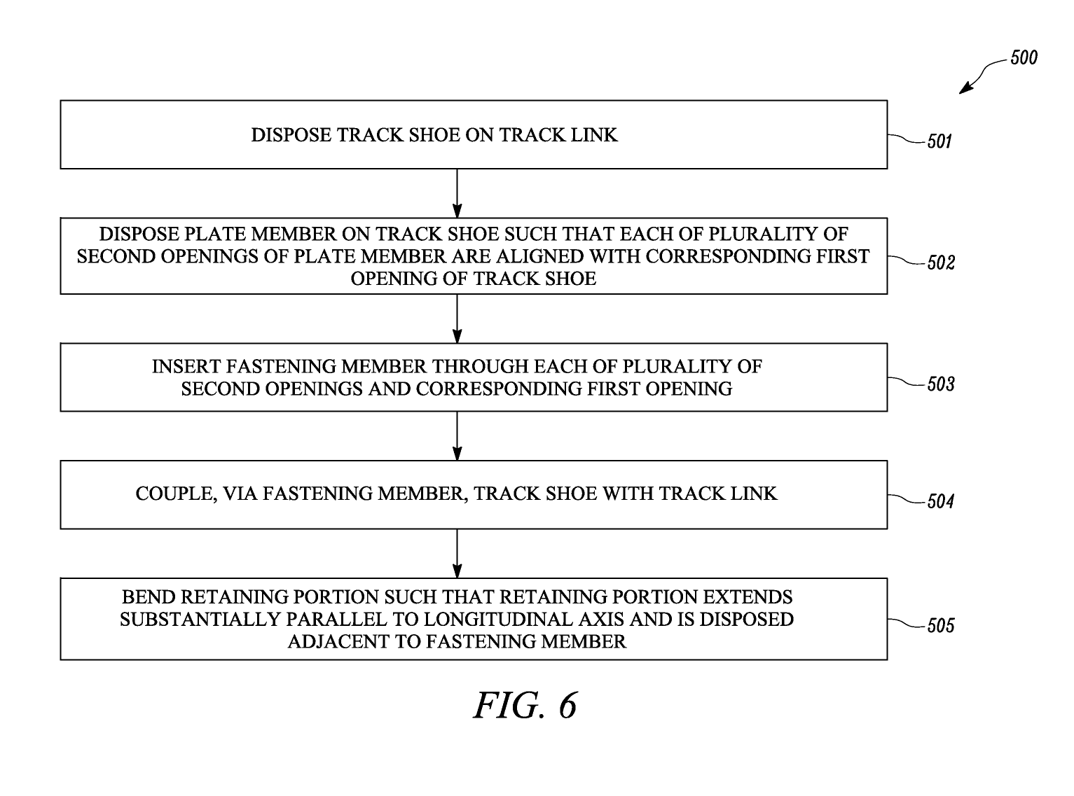

FIG. 6 illustrates a method 500 of assembling the track shoe 130 to the track link 126 of the track assembly 109.

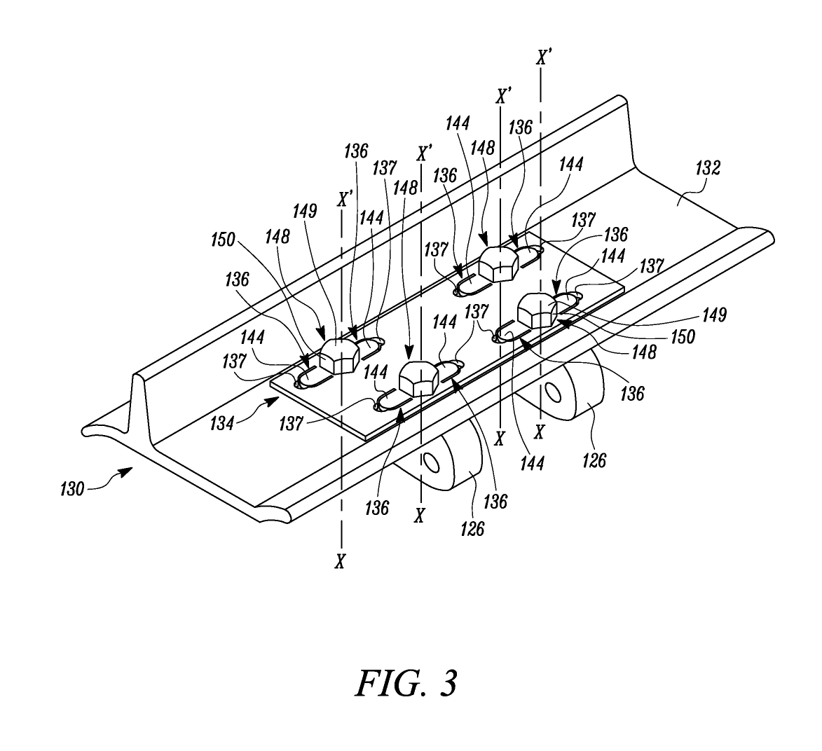

Referring to FIGS. 1 to 4, at step 501, the method 500 includes disposing the track shoe 130 on the track link 126. The track shoe 130 is disposed on the track link 126 such that each of the first openings 138 is aligned with a corresponding hole (not shown) of the track links 126.

At step 502, the method 500 includes disposing the plate member 134 on the track shoe 130 such that each of a plurality of second openings 142 of the plate member 134 is aligned with the corresponding first openings 138 of the track shoe 130. Further, each of the plurality of second openings 142 defines a longitudinal axis X-X′ therethrough. The second openings 142 are aligned with the corresponding first openings 138 along the longitudinal axis X-X′. Further, the retaining portions 144 are disposed adjacent to each of the plurality of second openings 142. The retaining portions 144 extend along a direction substantially perpendicular to the longitudinal axis X-X′.

At step 503, the method 500 includes inserting a fastening member 148 through each of the second openings 142 and the corresponding first opening 138. In an example, the fastening member 148 may be a bolt. The fastening member 148 includes a head 149. The head 149 further includes a number of flat portions 150 disposed around the head 149. In the illustrated embodiment, the flat portions 150 are six in number such that the head 149 has a substantially hexagonal shape. Each of the fastening members 148 is inserted through each of the second openings 142, the corresponding first opening 138 and the corresponding hole of the track links 126 along the longitudinal axis X-X′.

At step 504, the method 500 includes coupling, via the fastening members 148, the track shoe 130 with the track links 126. In an embodiment, each of the fastening members 148 may include a threaded portion (not shown). The threaded portion of each of the fastening members 148 may engage with corresponding threads (not shown) defined in the track link 126. Alternatively, each of the fastening members 148 may be coupled to a nut.

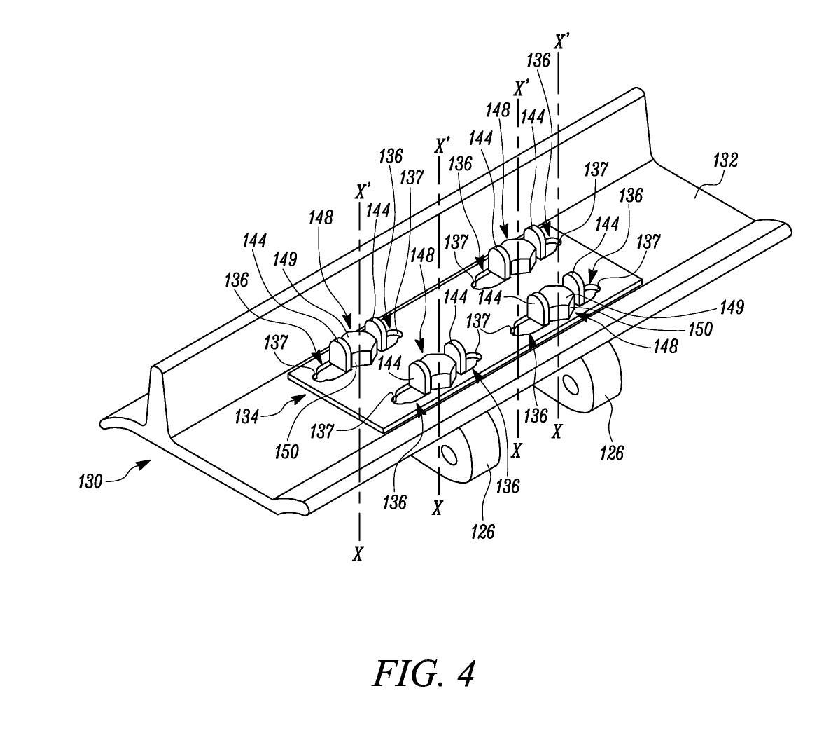

At step 505, the method 500 includes bending the retaining portions 144 such that the retaining portions 144 extend substantially parallel to longitudinal axis X-X′ and is disposed adjacent to the corresponding fastening member 148. The retaining portions 144 may be bent using a tool (not shown) such as chisel, claw hammer, and the like. The portions 137 of the notches 136 may be adapted to receive such tools. As illustrated in FIG. 4, two retaining portions 144 are disposed adjacent to a corresponding flat portion 150 of the head 149 of each of the fastening members 148. Further, the two retaining portions 144 extend substantially parallel to the longitudinal axis X-X′ to retain the corresponding fastening members 148 between them.

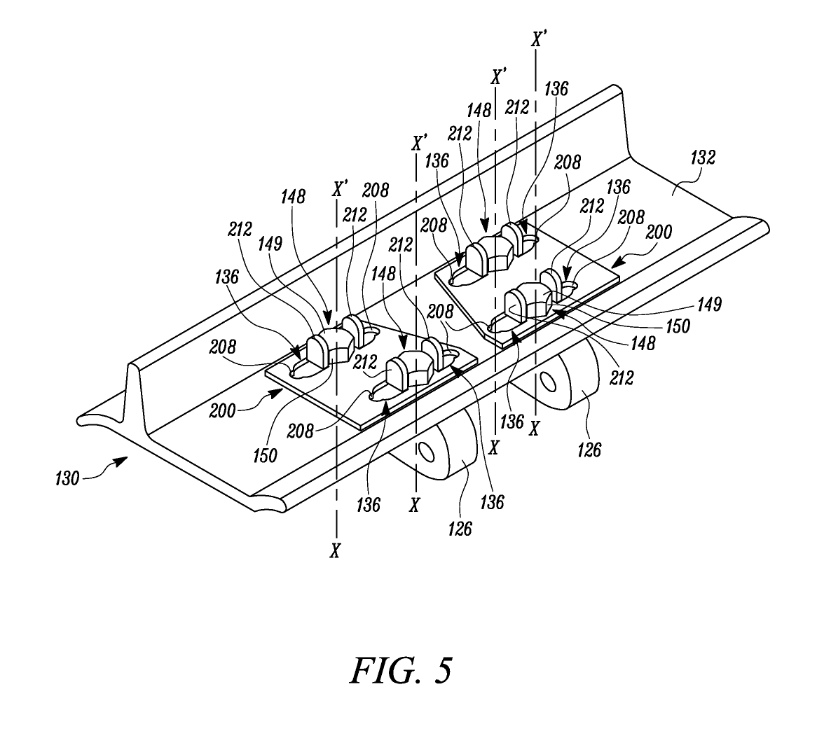

FIG. 5 shows a pair of plate members 200 assembled with the track shoe 130 and the track links 126. Each of the plate members 200 is coupled to one of the track links 126. The plate members 200 are disposed on the track shoe 130. Each of the plate members 200 includes a plurality of second openings 204. In the illustrated embodiment, each of the plate members 200 includes two second openings 204. Each of the plate members 200 further includes multiple notches 208 defined around the second openings 204. As shown in FIG. 5, each of the plate members 204 includes two notches 208 defined around each of the second openings 204. Further, a retaining portion 212 is disposed within each of the notches 208 such that two retaining portions 212 are disposed adjacent to each of the second opening 204. In the illustrated embodiment, the retaining portions 212 are integral with the plate member 200. As illustrated in FIG. 5, the retaining portions 212 are in an upright position such that the retaining portions 212 extend along the longitudinal axis X-X′. However, before assembly, the retaining portions 212 extend along a direction substantially perpendicular to the longitudinal axis X-X′.

The plate members 200 may be assembled with the track shoe 130 and the track links 126 via the fasteners 148 in a manner similar to the method 500 described above. Specifically, the second openings 204 of the plate members 200 are aligned with the corresponding first openings 138 of the track shoe 130. The fastening members 148 are inserted within the corresponding first and second openings 138, 204. The track shoe 130 and the track links 126 are coupled via the fasteners 148. The retaining portions 212 are then bent such that the retaining portions 212 extend along the longitudinal axis X-X′. Further, two retaining portions 212 are adapted to retain the corresponding fastening member 148 between them.

### INDUSTRIAL APPLICABILITY

The present disclosure is related to the method 500 of coupling each of the track shoes 130 with the corresponding track links 126 of the track assembly 109 using the plate members 200, 134 and the fastening members 148. As described above, the plate members 134, 200 include the retaining portions 144, 212 disposed adjacent to each of the second openings 142, 204 of the plate members 134, 200.

Before assembly, the retaining portions 144, 212 extend along a direction substantially perpendicular to the longitudinal axis X-X′ defined by the second openings 142, 204. Further, the retaining portions 144, 212 are bent such that the retaining portion 144, 212 extend substantially parallel to longitudinal axis X-X′ and are disposed adjacent to the corresponding flat portions 149 of the head 150 of the fastening member 148. Each of the fastening members 148 is disposed between two retaining portions 144, 212. This may prevent a movement and/or loosening of the fastening members 148 during operation of the machine 100.

Further, the track shoe 130 may be removed from the track assembly 109 by bending the retaining portions 144, 212 of the plate member 134, 200 such that the retaining portions 144, 212 extend perpendicular to the longitudinal axis X-X′. The fastening member 148 may then be loosened to remove the track shoe 130 for servicing and/or replacement purposes. Hence, method 500 may enable the track shoe 130 to be assembled with or disassembled from the corresponding track links 126 without using any specialized tools or equipment and easily implemented during servicing and/or maintenance.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of coupling a track shoe with a track link of a track assembly, the track shoe defining a plurality of first openings, the method comprising:
disposing the track shoe on the track link;
disposing a plate member on the track shoe such that each of a plurality of second openings of the plate member is aligned with a corresponding first opening of the plurality of first openings of the track shoe, the plate member further comprising a retaining portion disposed adjacent to each of the plurality of second openings, wherein each of the plurality of second openings define a longitudinal axis therethrough, and wherein the retaining portion extends along a direction substantially perpendicular to the longitudinal axis;
inserting a fastening member through each of the plurality of second openings and the corresponding first opening;
coupling, via the fastening member, the track shoe with the track link; and
bending the retaining portion such that the retaining portion extends substantially parallel to the longitudinal axis and is disposed adjacent to the fastening member.
